(19) United States
(12) Patent Application Publication
(10) Pub. No.: US 2026/0155968 A1
(43) Pub. Date: Jun. 4, 2026

(54) ELECTRONIC DEVICE AND CONTROL METHOD THEREOF

(71) Applicant: SAMSUNG ELECTRONICS CO., LTD., Suwon-si (KR)

(72) Inventors: Jeongmin KIM, Suwon-si (KR); Yongwook Kim, Suwon-si (KR); Euisik Kim, Suwon-si (KR); Jean-Christophe Naour, Suwon-si (KR)

(73) Assignee: SAMSUNG ELECTRONICS CO., LTD., Suwon-si (KR)

(21) Appl. No.: 19/397,225

(22) Filed: Nov. 21, 2025

Related U.S. Application Data
(63) Continuation of application No. PCT/KR2025/011369, filed on Jul. 30, 2025.

(30) Foreign Application Priority Data
Jul. 30, 2024 (KR) 10-2024-0101315
Apr. 28, 2025 (KR) 10-2025-055189

(51) Int. Cl. H04L 9/08

(52) U.S. Cl. CPC H04L 9/088

(57) ABSTRACT

An electronic device may include: memory storing instructions; and at least one processor, wherein the instructions, when executed by the at least one processor collectively or individually, cause the electronic device to: generate a first feature value and a first key value that correspond to first data; obtain second data by inserting the first key value into the first data; match the first feature value to the first key value and transmit a matched value to a server device; based on third data being obtained, obtain a second feature value corresponding to the third data and a second key value in the third data; and determine whether the second data is in the third data based on a result of comparing the first feature value with the second feature value and a result of comparing the first key value with the second key value.

### CROSS-REFERENCE TO RELATED APPLICATION

This application is a continuation application of International Patent Application No. PCT/KR2025/011369, filed on Jul. 30, 2025, which claims priority from Korean Patent Application No. 10-2024-0101315, filed on Jul. 30, 2024, in the Korean Intellectual Property Office, and Korean Patent Application No. 10-2025-0055189, filed on Apr. 28, 2025, in the Korean Intellectual Property Office, the disclosures of which are incorporated herein by reference in their entireties.

### BACKGROUND

### 1. Field

The present disclosure relates to an electronic device and a method for controlling the same, and more particularly, to an electronic device for determining whether data is falsified and a method for controlling the same.

### 2. Description of Related Art

Recently, various types of content generated by artificial intelligence (AI) are increasing as AI generation technology advances.

However, according to related art, it is difficult to confirm whether obtained data is falsified data.

Accordingly, it is desired to determine whether various types of data are falsified data.

### SUMMARY

According to an aspect of the disclosure, an electronic device may include: memory storing instructions; and at least one processor, wherein the instructions, when executed by the at least one processor collectively or individually, cause the electronic device to: generate a first feature value and a first key value that correspond to first data; obtain second data by inserting the first key value into the first data; match the first feature value to the first key value and transmit a matched value to a server device; based on third data being obtained, obtain a second feature value corresponding to the third data and a second key value in the third data; determine whether the second data is in the third data based on a result of comparing the first feature value with the second feature value and a result of comparing the first key value with the second key value; determine whether the third data is falsified based on an identification result; and output information identifying whether the third data is falsified.

The instructions, when executed by the at least one processor collectively or individually, may further cause the electronic device to: determine whether a key value matching the second key value in the third data is stored in the server device; obtain the first feature value matching the first key value and stored in the server device based on the server device including the first key value matching the second key value; and identify the third data as non-falsified data based on the first feature value and the second feature value matching.

The instructions, when executed by the at least one processor collectively or individually, may further cause the electronic device to: generate the first key value based on at least one of a random number generation algorithm, a hash algorithm, binary information of the first data, or user information.

The instructions, when executed by the at least one processor collectively or individually, may further cause the electronic device to: divide the first data into a plurality of blocks based on the first data being image data; and generate the first feature value based on a hash value of a block of the plurality of blocks in the divided first data.

The instructions, when executed by the at least one processor collectively or individually, may further cause the electronic device to: identify a key frame from among a plurality of frames in the first data based on the first data being video data or audio data; and generate the first feature value based on feature information of the identified key frame.

The first feature value may include information on at least one of content, capacity, format, resolution, or block size of the first data.

The instructions, when executed by the at least one processor collectively or individually, may further cause the electronic device to: identify the third data as falsified data based on the second key value not matching the first key value or the second key value in the third data being not obtainable.

The instructions, when executed by the at least one processor collectively or individually, may further cause the electronic device to: identify the third data as the falsified data based on the second feature value and the first feature value not matching.

The instructions, when executed by the at least one processor collectively or individually, may further cause the electronic device to: divide the third data into a plurality of blocks; and identify that one or more blocks in the divided third data are falsified based on hash values of the one or more blocks and hash values of one or more blocks in the divided first data not matching.

According to an aspect of the disclosure, a method for controlling an electronic device, the may include: generating a first feature value and a first key value that correspond to first data; obtaining second data by inserting the first key value into the first data; matching the first feature value to the first key value and transmitting a matched value to a server device; obtaining a second feature value corresponding to third data and a second key value in the third data based on the third data being obtained; determining whether the second data is in the third data based on a result of comparing the first feature value with the second feature value and a result of comparing the first key value with the second key value; determining whether the third data is falsified based on an identification result; and outputting information identifying whether the third data is falsified.

The method may further include: determining whether a key value matching the second key value in the third data is stored in the server device; obtaining the first feature value matching the first key value and stored in the server device based on the server device including the first key value matching the second key value; and identifying the third data as non-falsified data based on the first feature value and the second feature value matching.

The generating of the first feature value may include generating the first key value based on at least one of a random number generation algorithm, a hash algorithm, binary information of the first data, or user information.

The obtaining of the first feature value may include: dividing the first data into a plurality of blocks based on the first data being image data; and generating the first feature value based on a hash value of a block of the plurality of blocks in the divided first data.

The obtaining of the first feature value may include: identifying a key frame from among a plurality of frames in the first data based on the first data being video data or audio data; and generating the first feature value based on feature information of the identified key frame.

According to an aspect of the disclosure, a non-transitory computer-readable recording medium storing computer instructions executed by at least one processor of an electronic device to cause the electronic device to perform a method for controlling the electronic device that may include: generating a first feature value and a first key value that correspond to first data; obtaining second data by inserting the first key value into the first data; matching the first feature value to the first key value and transmitting a matched value to a server device; obtaining a second feature value corresponding to third data and a second key value in the third data based on the third data being obtained; determining whether the second data is in the third data based on a result of comparing the first feature value with the second feature value and a result of comparing the first key value with the second key value; determining whether the third data is falsified based on an identification result; and output information identifying whether the third data is falsified.

The method may further include: determining whether a key value matching the second key value in the third data is stored in the server device; obtaining the first feature value matching the first key value and stored in the server device based on the server device including the first key value matching the second key value; and identifying the third data as non-falsified data based on the first feature value and the second feature value matching.

The method may further include: generating the first key value based on at least one of a random number generation algorithm, a hash algorithm, binary information of the first data, or user information.

The method may further include: dividing the first data into a plurality of blocks based on the first data being image data; and generating the first feature value based on a hash value of a block of the plurality of blocks in the divided first data.

The method may further include: identifying a key frame from among a plurality of frames in the first data based on the first data being video data or audio data; and generating the first feature value based on feature information of the identified key frame.

The first feature value may include information on at least one of content, capacity, format, resolution, or block size of the first data.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing one or more embodiments of an electronic device according to one or more embodiments of the present disclosure;

FIG. 2 is a block diagram for describing the electronic device according to one or more embodiments of the present disclosure;

FIG. 3 is a flowchart for describing an operation for identifying whether the obtained data is falsified data according to one or more embodiments of the present disclosure;

FIG. 4 is a diagram for describing an operation for generating a feature value and a key value from original data according to one or more embodiments of the present disclosure;

FIG. 5 is a diagram for describing an operation for generating a feature value and a key value from original data according to one or more embodiments of the present disclosure;

FIG. 6 is a diagram for describing an operation for identifying whether the generated key value is the original data after generating the key value according to one or more embodiments of the present disclosure;

FIG. 7 is a diagram for describing an operation for identifying whether the generated key value is the original data after generating the key value according to one or more embodiments of the present disclosure; and

FIG. 8 is a flowchart for describing a method for controlling an electronic device according to one or more embodiments of the present disclosure.

### DETAILED DESCRIPTION

The present disclosure may be variously modified and have several embodiments, and specific embodiments of the present disclosure are thus illustrated in the accompanying drawings and described in detail in this specification. However, it should be understood that the scope of the present disclosure are not limited to specific embodiments, and include all modifications, equivalents, and alternatives according to one or more embodiments of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression “have”, “may have”, “include”, “may include” or the like, indicates the presence of a corresponding feature (for example, a numerical value, a function, an operation, or a component such as a part), and does not exclude the presence of an additional feature.

In the present disclosure, the expression “A or B”, “least one of A and/or B” or “one or more of A and/or B” or the like may include all possible combinations of items enumerated together. For example, “A or B,” “at least one of A and B”, or “at least one of A or B” may indicate all of 1) a case in which at least one A is included, 2) a case in which at least one B is included, or 3) a case in which both of at least one A and at least one B are included.

The expressions “first”, “second”, and the like used in the present disclosure may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

On the other hand, if any component (for example, the first component) is mentioned to be “directly coupled with/to” or “directly connected to” another component (for example, the second component), it should be understood that yet another component (for example, the third component) is not present between any component and another component.

An expression “configured (or set) to” used in the present disclosure may be replaced by an expression “suitable for”, “having the capacity to”, “designed to”, “adapted to”, “made to” or “capable of” based on a context. The expression “configured (or set) to” may not necessarily indicate “specifically designed to” in hardware.

Instead, an expression a “device configured to” in any context may indicate that the device may “perform˜” together with another device or component. For example, a “processor configured (or set) to perform A, B, and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by the processor 160 except for a “module” or a “part” that needs to be implemented by specific hardware.

Meanwhile, the various elements and areas in the drawings are schematically shown. Therefore, the spirit of the present disclosure is not limited by relative sizes or intervals shown in the accompanying drawings.

Hereinafter, the embodiments of the present disclosure are described in detail with reference to the accompanying drawings.

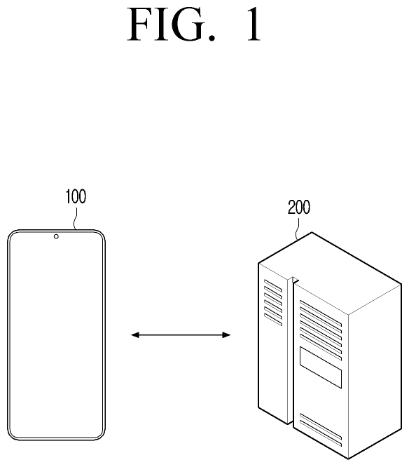

FIG. 1 is a schematic diagram showing a system including an electronic device and a server device according to one or more embodiments of the present disclosure. As shown in FIG. 1, the system may include an electronic device 100 and a server device 200.

FIG. 1 shows that the electronic device 100 is implemented as a portable device such as a smartphone. However, the electronic device 100 is not limited thereto, and may be implemented as any of various types of electronic devices such as a tablet, a laptop computer, a television (TV), a camera, and a personal computer (PC).

The electronic device 100 may obtain non-falsified data (or, original data). Here, a type of the data obtained by the electronic device 100 may be an image, a video, or an audio. For convenience of description, the non-falsified data is defined as first data and described below.

The electronic device 100 may generate a first feature value and a first key value that correspond to the first data.

Here, “the feature value” may be a value that expresses a unique feature of data in the form of a number or a code. In addition, “the feature value” may be defined as a “hash value,” “metadata,” or “signature data.”

Meanwhile, “the key value” may indicate a unique value corresponding to the data. In addition, “the key value” may be defined as a watermark or an identifier. “The key value” may also serve as an index value for obtaining the feature value.

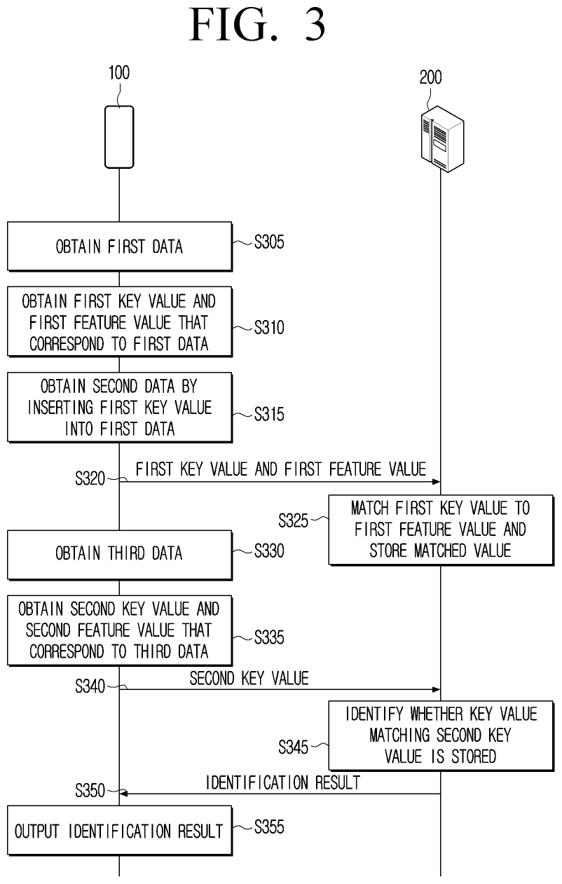

A method for obtaining the feature value and the key value for each data type is specifically described below with reference to FIGS. 3 to 6.

The electronic device 100 may obtain the first key value corresponding to the first data and then insert the first key value into the first data. For the convenience of description, the first data into which the first key value is inserted is defined as second data and described below.

The electronic device 100 may match the first feature value corresponding to the first data to the first key value included in the second data and transmit a matched value to the server device 200. However, this configuration is only one or more embodiments, and the server device 200 may also match the first feature value to the first key value and store a matched value.

Meanwhile, for the convenience of description, one or more embodiments in which the first feature value and the first key value are matched to each other and stored is assumed and described, which is only one or more embodiments, and one or more embodiments in which no values are matched to each other and stored is also possible. However, even in this case, the server device 200 may identify the first feature value corresponding to the first key value.

Next, the electronic device 100 may obtain data, whether the original data or not, by using a camera 130 or a microphone 140. For the convenience of description, the data, whether the original data or not, is defined as third data and described below.

The electronic device 100 may obtain a second key value corresponding to the third data.

Here, the electronic device 100 may identify the third data as falsified data if the second key value corresponding to the third data is not obtainable. “Not obtainable” may mean that the second key value does not compute, is not received, or is calculated and does not match the first key value.

The electronic device 100 may transmit the second key value to the server device 200 if the electronic device 100 obtains the second key value corresponding to the third data. The server device 200 may determine whether a key value matching the second key value exists among a plurality of key values stored therein.

If the key value matching the second key value is not stored in the server device 200, the electronic device 100 may identify the third data as falsified data. “Falsified” may bean counterfeit data, data that has been modified from the original or authentic data, or data that does not match the original or authentic data.

If the key value matching the second key value is stored in the server device 200, the electronic device 100 may receive a feature value (or properties) matching the key value determined as matching the second key value from the server device 200.

The electronic device 100 may determine whether the feature value obtained from the server device 200 and a second feature value corresponding to the third data match to each other. The electronic device 100 may identify the third data as the original data if the electronic device 100 determines that the second feature value and the feature value obtained from the server device 200 match to each other.

On the other hand, the electronic device 100 may identify the third data as falsified data if the electronic device 100 determines that the second feature value and the feature value obtained from the server device 200 do not match to each other.

The description below specifically describes the operations of the electronic device 100 for storing (or registering) the first key value and the first feature value that correspond to the first data in the server device 200 and for identifying whether the third data is the original data.

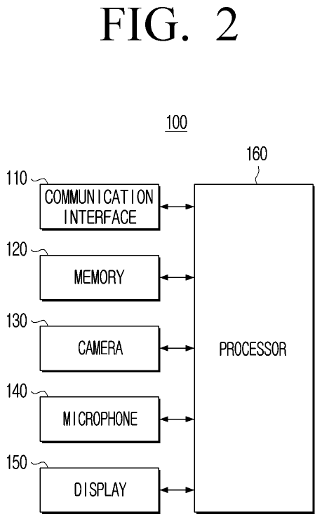

FIG. 2 is a block diagram for describing a configuration of the electronic device 100. The configuration shown in FIG. 2 is only one or more embodiments, and some components may be omitted and new components may be added. As shown in FIG. 2, the electronic device 100 may include a communication interface 110, a memory 120, the camera 130, the microphone 140, a display 150, and a processor 160. The configuration shown in FIG. 2 is only one or more embodiments, and some components may be deleted or added depending on the configuration of the electronic device 100.

First, the communication interface 110 is a component for performing communication with various types of external devices depending on various types of communication methods. In particular, the communication interface 110 may transmit the feature value and the key value to the server device 200. Alternatively, the communication interface 110 may receive the feature value and the key value from the server device 200.

A wireless communication module may be a module that communicates with the external device in a wireless manner. For example, the wireless communication module may include at least one of a wireless fidelity (Wi-Fi) module, a Bluetooth module, an infrared communication module, an ultra wide-band (UWB) module, or other communication modules.

In detail, the wireless communication module may include at least one communication chip that performs the communication depending on various wireless communication standards such as Zigbee, Universal Serial Bus (USB), Mobile Industry Processor Interface Camera Serial Interface (MIPI CSI), Third Generation (3G), Third Generation Partnership Project (3GPP), Long Term Evolution (LTE), LTE Advanced (LTE-A), Fourth Generation (4G), and Fifth Generation (5G), in addition to the above-described communication method. However, this configuration is only one or more embodiments, and the communication interface 110 may use at least one communication module among various communication modules.

A wired communication module may be a module that communicates with the external device via a wire. For example, the wired communication module may include at least one of a Local Area Network (LAN) module, an Ethernet module, a pair cable, a coaxial cable, or a fiber optic cable.

The memory 120 may store an operating system (OS) for controlling overall operations of components included in the electronic device 100 and instructions or data related to the components of the electronic device 100. In particular, the memory 120 may be implemented in any of various forms, such as a volatile memory (e.g., a Dynamic Random Access Memory (DRAM), a Static RAM (SRAM), or a Synchronous Dynamic RAM (SDRAM)) or a non-volatile memory (e.g., a One-Time Programmable Read Only Memory (OTPROM), a Programmable ROM (PROM), an Erasable and Programmable ROM (EPROM), an Electrically Erasable and Programmable ROM (EEPROM), a mask ROM, or a flash ROM, a flash memory (e.g., a NAND flash or a NOR flash), a hard drive, or a Solid State Drive (SSD)).

In particular, the memory 120 may store the first data and the third data. In addition, the memory 120 may store the first feature value and the first key value that correspond to the first data received from the server device 200. The memory 120 may also store the second feature value and the second key value that correspond to the third data.

The camera 130 may capture a still image and video. The camera 130 may include at least one image sensor (e.g., a front sensor or a rear sensor), a lens, an image signal processor (ISP), or a flash (e.g., a Light-Emitting Diode (LED) or a xenon lamp).

In particular, the camera 130 may obtain an image or video of surroundings of the electronic device 100. Here, the obtained image or video may include at least one object. The object may be any of various types of things such as a person, a piece of paper, and an electronic device.

The microphone 140 may indicate a module that obtains an audio signal including an external voice signal and a noise signal and converts the obtained signal into an electric signal, and may be a condenser microphone, a ribbon microphone, a moving coil microphone, a piezoelectric element microphone, a carbon microphone, or a Micro Electro Mechanical System (MEMS) microphone. In addition, the microphone 140 may be implemented in an omnidirectional, bidirectional, unidirectional, subcardioid, supercardioid, or hypercardioid manner. In particular, the microphone 140 may receive a voice signal of a user and a noise signal around the user or the electronic device 100.

The at least one processor may output information identifying whether the third data is falsified data to e.g. the display 150. The display 150 may display various information. In particular, the display 150 may display a user interface (UI) that displays a result of identifying whether the third data is falsified data.

The display 150 may be implemented as any of various types of displays, such as a Liquid Crystal Display (LCD), an Organic Light-Emitting Diode (OLED) display, and a Plasma Display Panel (PDP). The display may also include a driving circuit, a backlight unit, and the like, which may be implemented in a form such as an a-Si Thin Film Transistor (TFT), a Low Temperature Poly Silicon (LTPS) TFT, or an Organic TFT (OTFT). The display may be implemented as a touchscreen coupled to a touch sensor, a flexible display, a three-dimensional display, or the like. The display 150 according to various embodiments of the present disclosure may include not only a display panel that outputs an image, but also a bezel that houses the display panel.

The processor 160 may include at least one processor. In detail, at least one processor may include at least one of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The processor 160 may control one or any combination of other components included in the electronic device, and perform an operation related to the communication or data processing. At least one processor may execute at least one program or instruction stored in the memory. For example, at least one processor may perform a method according to one or more embodiments of the present disclosure by executing at least one instruction stored in the memory.

At least one processor may be implemented as a single-core processor including a single core, or may be implemented as at least one multi-core processor including multiple cores (e.g., homogeneous multiple cores or heterogeneous multiple cores). If at least one processor is implemented as the multi-core processor, each of the multiple cores included in the multi-core processor may include a processor internal memory such as a cache memory or an on-chip memory, and a common cache shared by the multiple cores may be included in the multi-core processor. In addition, each (or some) of the multiple cores included in the multi-core processor may independently read and perform a program instruction for implementing the method according to one or more embodiments of the present disclosure, or all (or some) of the multiple cores may be linked with each other to read and perform the program instruction for implementing the method according to one or more embodiments of the present disclosure.

In particular, the processor 160 may generate the first feature value and the first key value that correspond to the first data, obtain the second data by inserting the first key value into the first data, match the first feature value to the first key value and transmit the matched value to the server device, obtain the second feature value corresponding to the third data and the second key value included in the third data if the third data is obtained, determine whether the second data is included in the third data based on a result of comparing the first feature value with the second feature value and a result of comparing the first key value with the second key value, and determine whether the third data is falsified based on an identification result.

The processor 160 may determine whether the key value matching the second key value included in the third data is stored in the server device, obtain the first feature value matching the first key value stored in the server device if the server device includes the first key value matching the second key value, and identify the third data as the non-falsified data if the first feature value and the second feature value match each other.

The processor 160 may generate the key value corresponding to the first data by using at least one of a random number generation algorithm, a hash algorithm, binary information of the first data, or user information.

The processor 160 may divide the first data into a plurality of blocks if the first data is the image data, and obtain the feature value corresponding to the first data by using a hash value of the block included in the divided first data.

The processor 160 may identify a key frame from among a plurality of frames included in the first data if the first data is video data or audio data, and generate the feature value corresponding to the first data by using feature information of the identified key frame. The feature value may include at least one of information on the capacity, format, and resolution of the first data, or at least one of information on a block size if the first data is divided into the plurality of blocks.

The processor 160 may identify the third data as falsified data if the key value corresponding to the third data does not match the key value corresponding to the first data or the key value corresponding to the third data is not obtainable.

The processor 160 may identify the third data as falsified data if the feature value corresponding to the third data and the feature value corresponding to the first data do not match each other.

The processor 160 may divide the third data into a plurality of blocks, and determine that some blocks included in the third data are falsified if hash values of some blocks among the plurality of blocks included in the divided third data and hash values of some blocks included in the divided first data do not match each other.

Hereinafter, each step described above is specifically described below with reference to FIGS. 3 to 7.

FIG. 3 is a flow chart for describing an operation for matching the key value to the feature value and storing the matched value in the server device according to one or more embodiments of the present disclosure.

First, the electronic device 100 may obtain the first data (S305).

The first data may indicate the non-falsified data (i.e., the original data or raw data). Here, the first data may be one of the image data, voice data, or the video data.

In at least one embodiment, the electronic device 100 may obtain the first data through the camera 130. The camera 130 may obtain the image or video of the surroundings of the electronic device 100. Here, the image may be one frame among the plurality of frames included in the video.

In at least one embodiment, the electronic device 100 may obtain the first data related to a user voice through the microphone 140. For example, if the user utters a voice command or executes a recording function, the microphone 140 may detect a sound wave, convert the detected sound wave into an analog signal, and then convert the analog signal into a digital signal.

In at least one embodiment, the electronic device 100 may obtain the first data stored in the memory 120. The data stored in the memory 120 may be data previously inputted by the electronic device 100 from the external device and then stored.

The electronic device 100 may obtain (or generate) the first key value and the first feature value that correspond to the first data (S310).

Here, the first key value may indicate the unique value corresponding to the first data. In addition, “the key value” may be the watermark or the identifier. “The key value” may also serve as the index value for obtaining the feature value.

If the key value serves as the index value, the key value may be used to quickly identify (or search for) specific data (e.g., the feature value) from the server device 200 or from the database stored in the server device 200. For example, if the key value corresponding to a specific image is 123ABC, a value of 123ABC may be used to identify the specific image (or the feature value corresponding to the image).

The key value may be generated using at least one of the random number generation algorithm, the hash algorithm, the binary information, or the user information. The random number generation algorithm may indicate an algorithm that generates a random number by using a Pseudo-Random Number Generator (PRNG) inside the electronic device 100. The hash algorithm may indicate a SHA-256 algorithm or an MD5 algorithm. The user information may indicate user-specific information. Here, the user-specific information may be a user identification (ID), a user name, or user email address information.

In addition, the first feature value may indicate feature data corresponding to the first data. “The feature value” may be a value that expresses the unique feature of data in the form of a number or a code. In addition, “the feature value” may be the “hash value”, the “meta data”, or the “signature data”.

The feature value may be generated using the hash algorithm or the meta data. If the feature value is generated using the hash algorithm, the data may be converted into a unique value having a fixed length. In addition, if the feature value is generated using the meta data, the meta data may be the resolution (e.g., 1920×1080), file size (e.g., 3 MB), generation date (e.g., 2025 Jan. 5), or format (e.g., JPEG) of the first data.

Meanwhile, for the convenience of description, one or more embodiments of obtaining the first feature value and then generating the first key value is described below, which is only one or more embodiments. One or more embodiments of generating the first key value and then generating the first feature value, or one or more embodiments of simultaneously generating the first key value and the first feature value is also possible.

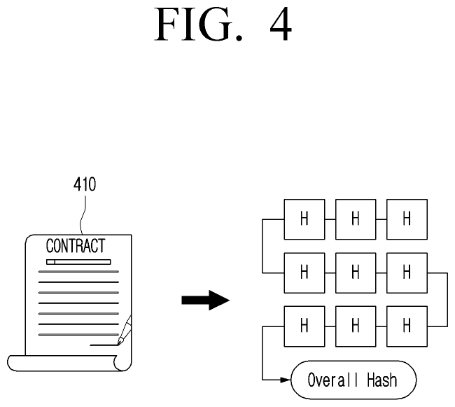

FIG. 4 is a diagram for describing a method for generating the feature value corresponding to the image data according to one or more embodiments of the present disclosure.

The electronic device 100 may divide first data 410 into a plurality of blocks if the first data 410 is the image data, and generate the feature value corresponding to the first data 410 by using the hash value of the block included in the divided first data 410.

Here, the feature value may include at least one of information on the content, capacity, format, and resolution of the first data 410, or may include information on a block size if the first data 410 is divided into a plurality of blocks.

In detail, the electronic device 100 may divide the image data into a plurality of blocks, and generate a hash value by applying the hash algorithm to each of the divided blocks.

In at least one embodiment, the SHA-256 algorithm among the hash algorithms may be used for the electronic device 100 to generate an output value of 256 bits (32 bytes). In detail, the electronic device 100 may divide the data into 512-bit blocks, and each block may be used for the electronic device 100 to perform a hash operation. After the hash operation, the electronic device 100 may obtain the hash value by using an operation (e.g., bit shift or bit XOR).

In at least one embodiment, the Message Digest Algorithm 5 (MD5 algorithm) among the hash algorithms may be used to generate an output value of 128 bits (i.e., 16 bytes). In detail, the electronic device 100 may divide the data into 512-bit blocks and perform 64 rounds of operation.

In at least one embodiment, the SHA-1 algorithm among the hash algorithms may be used for the electronic device 100 to generate an output value of 160 bits (i.e., 20 bytes). In detail, the electronic device 100 may divide the data into 512-bit blocks and generate a 160-bit hash value through 80 rounds of operation.

As shown in FIG. 4, the electronic device 100 may divide a contract image (first data 410) into nine blocks (or regions), and then generate a hash value for each of the nine blocks by using at least one of the hash algorithms described above.

Meanwhile, for the convenience of description, one or more embodiments of dividing the contract image (first data 410) into the nine blocks is described below, which is only one or more embodiments, and the number of divided blocks may vary depending on an intended use.

The hash value generated for each of the nine blocks may include information on contents included in each block, pixel data of the image, the format (e.g., JPEG or PNG), or the resolution. In addition, the hash value may include structural information of the block.

In detail, the pixel data may include information on the brightness or color of a pixel. In addition, the hash value may include the structural information of the block, and thus include information on an arrangement order of the blocks and an arrangement of the pixels.

The electronic device 100 may generate an overall hash value (i.e., an overall hash) based on the plurality of generated hash values.

In at least one embodiment, the electronic device 100 may generate the overall hash value (i.e., the overall hash) by using a simple concatenation method. The simple concatenation method may indicate a method for dividing the image data into the plurality of blocks, calculating a hash value for each block, and sequentially concatenating (or listing) the calculated hash values to generate a single hash value representing entire data.

For example, the electronic device 100 may have a hash value generated from a first block as H₁, a hash value generated from a second block as H₂, and a hash value generated from an Nth block as H_{N}. Here, the electronic device 100 may store a hash value corresponding to the first data 410 as {H₁|H₂|H₃| . . . |H_{N}}.

In at least one embodiment, the electronic device 100 may generate the overall hash value (i.e., the overall hash) by using circular chain method. The circular chain method may indicate a method for calculating the hash value for each block by coupling a hash value for a previous block to a hash value for a current block.

For example, as shown in FIG. 4, if the electronic device 100 obtains the hash value for the second block, the electronic device 100 may generate the hash value for the second block by using the hash value for the first block. In addition, if the electronic device 100 obtains a hash value for the third block, the electronic device 100 may generate the hash value for the third block by using the hash value for the second block. By repeating the above-described operation, the electronic device 100 may generate one hash value (i.e., the overall hash) corresponding to first data 410.

In at least one embodiment, the electronic device 100 may generate the overall hash value by using a multi-hash combination method. The multi-hash combination method may indicate a method for simultaneously using different hash algorithms to combine the hash values for the respective blocks with each other.

For example, the electronic device 100 may apply multiple-hash algorithms to the first block. The electronic device 100 may combine values obtained by applying multiple-hash algorithms with each other.

However, this configuration is only one or more embodiments, and the electronic device 100 may obtain the hash value by converting the hash value for each block into a bit map form and combine the hash values with each other or by weighting each block based on its importance.

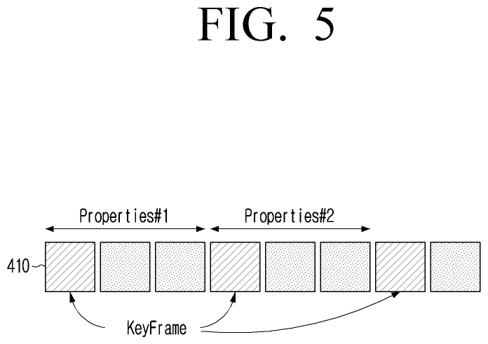

FIG. 5 is a diagram for describing a method for obtaining the feature value corresponding to the data if the data is the audio data or the video data according to one or more embodiments of the present disclosure.

In detail, the electronic device 100 may identify the key frame from among the plurality of frames included in the first data 410 if the first data 410 is the video data or the audio data. Here, the electronic device 100 may generate the feature value (properties) corresponding to the first data 410 by using the feature information of the identified key frame.

The key frame (a representative frame or a reference frame) may indicate a frame in the video data or the audio data that includes important information.

In at least one embodiment, the electronic device 100 may identify the key frame based on a predetermined time interval. For example, the electronic device 100 may identify the key frame at a three-second interval.

In at least one embodiment, the electronic device 100 may identify the key frame based on a pixel change rate between consecutive frames if the first data 410 is the video data. For example, the electronic device 100 may identify a frame exceeding a threshold value as the key frame if the pixel change rate exceeds the threshold value.

However, this configuration is one or more embodiments. The electronic device 100 may identify the key frame by using a compression algorithm or a specific reference (e.g., an object included in the video data).

The electronic device 100 may identify the key frame by using the above-described method and then generate the hash value (or the feature value) for the key frame.

Here, the feature value (or the properties) may include at least one of the information on the content, capacity, format, and resolution of the first data 410, or may be a pixel value (e.g., a red-green-blue (RGB) value) included in the frame. In addition, if the first data 410 is the audio data, the first data 410 may also include information on the frequency spectrum or energy distribution of the key frame.

The electronic device 100 may obtain the key value from the first data. In detail, the electronic device 100 may generate the key value corresponding to the first data 410 by using at least one of the random number generation algorithm, the hash algorithm, binary information of the first data 410, or the user information.

In at least one embodiment, the electronic device 100 may obtain the first key value corresponding to the first data by using a random value. In detail, the electronic device 100 may generate the random value including a random number or string and set the generated random value as the key value.

In at least one embodiment, the electronic device 100 may obtain the first key value corresponding to the first data based on the hash value. A hash function indicates a function that converts input data into a unique output value having a fixed length. Here, if the same input data is input into the hash function, the same output value may be generated, thereby guaranteeing uniqueness.

In at least one embodiment, the electronic device 100 may obtain the first key value corresponding to the first data 410 by using a universally unique identifier (UUID) method. In detail, an UUID may indicate an identifier of 128 bits in length/having a 128-bit length to ensure the uniqueness. Here, the UUID may be expressed in the format of 8-4-4-4-12 (e.g., 550e8400-e29b-41d4-a716-446655440000).

However, this configuration is only one or more embodiments, and the electronic device 100 may obtain the first key value corresponding to the first data 410 by using ownership information or the user information. In detail, the ownership information may include the device information or owner information of the electronic device 100.

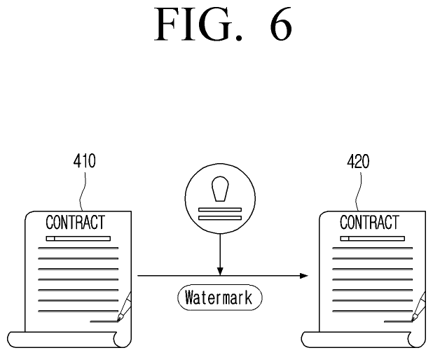

The electronic device 100 may obtain the second data by inserting the first key value into the first data (S315). This configuration is described below with reference to FIG. 6.

Supplementary data request part (Invisible watermark insertion algorithm)

Referring back to FIG. 3, the electronic device 100 may transmit the first key value and the first feature value to the server device 200 (S320).

The server device 200 may match the first key value to the first feature value and store the matched value (S325). Here, the server device 200 may separately obtain the first key value and the first feature value, then match the first key value to the first feature value, and store the matched value. However, this configuration is only one or more embodiments, and the first key value and the first feature value, already matched to each other, may be obtained from the electronic device 100.

In at least one embodiment, the server device 200 may store the first key value and the first feature value as a pair. In detail, the feature value corresponding to the first key value may be linked based on the first key value and then stored.

For example, if the first key value is UUID-1234-5678 and the first feature value is (1920×1080, JPEG, [H₁, H₂, H₃, . . . H_{N}]), the first key value and the first feature value may be matched to each other and stored.

In at least one embodiment, the server device 200 may store the first key value and the first feature value as a relational database. In detail, the relational database may store the data in the form of a table. Here, each data item may be stored as a row, and the feature value for the data may be stored as a column.

The electronic device 100 may obtain the third data (S330). Here, the third data may indicate data obtained from the external device or data stored in the memory 120, which has to be verified as being original.

Meanwhile, the third data may be the image data, the voice data, or the video data. A method for obtaining the third data is the same as the method for obtaining the first data, and a detailed description thereof is thus omitted.

Here, the electronic device 100 may obtain the second key value and the second feature value that correspond to the third data (S335). Meanwhile, the operation for obtaining the key value and the feature value that correspond to the data is described above, and a detailed description thereof is thus omitted.

The electronic device 100 may transmit the second key value to the server device 200 (S340).

Here, the server device 200 may identify whether the key value matching the second key value is stored therein (S345).

In at least one embodiment, if the key value and the feature value are stored as a pair in the server device 200, the server device 200 may identify the key value matching the second key value based on the second key value.

For example, if the key value corresponding to the first data is UUID-1234-5678, the server device 200 may determine whether UUID-1234-5678 exists among the key values, each of which is stored in the server device 200 as a pair with the feature value. If the server device 200 identifies the key value referred to as UUID-1234-5678, the server device 200 may identify the feature value matching UUID-1234-5678 and stored therein.

In at least one embodiment, if the key value and the feature value are stored as the relational database in the server device 200, a query may be executed to identify the second key value and identify the feature value matching the key value and stored therein.

For example, the key value corresponding to the first data may be UUID-1234-5678. Here, the electronic device 100 may execute a query of “SELECT*FROM ImageTable WHERE Key=“UUID-1234-5678”;” on the server device 200. Here, the server device 200 may determine whether the key value corresponding to “UUID-1234-5678” exists in a database referred to as Image Table. Here, the server device 200 may identify the feature value matching the key value and stored therein if the server device 200 executes the query and determines that the key value corresponding to “UUID-1234-5678” exists in the database.

On the other hand, the server device 200 may determine that the key value matching the second key value does not exist in the database as a result of executing the query.

The server device 200 may transmit the identification/determination result to the electronic device 100 (S350). In detail, the identification/determination result may include information on whether the key value matching the second key value exists, and information on the feature value matching the matching key value and stored in the server device 200 if the key value matching the second key value exists.

In addition, the identification/determination result may include information on whether the second data is included in the third data. In detail, if the second data is included in the third data, the identification/determination result may include information on whether the first key value inserted in the second data and the second key value extracted from the third data match each other as a result of comparing the two values.

The electronic device 100 may output the identification/determination result (S355).

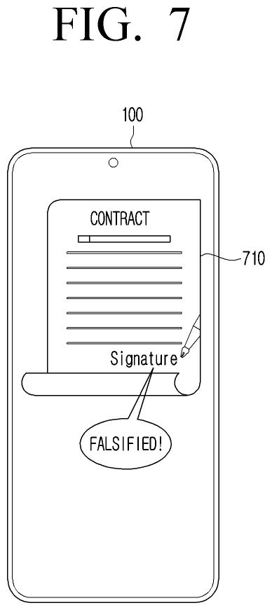

If the electronic device 100 determines that the key value matching the second key value exists, the electronic device 100 may compare the second feature value corresponding to the third data with the first feature value obtained from the server device 200. Here, if the electronic device 100 determines that the second feature value corresponding to the third data and the first feature value obtained from the server device 200 match each other, the electronic device 100 may identify the third data as the original data. In this case, the electronic device 100 may output content “The contract is the original data” as shown in FIG. 7.

On the other hand, if the electronic device 100 determine that the server device 200 does not include the key value matching the second key value, the electronic device 100 may determine that the third data is falsified data. In this case, as shown in FIG. 7, the electronic device 100 may display text “falsified” on the display 150.

In addition, the electronic device 100 may determine whether some regions of third data 710 are falsified by comparing the first feature value obtained from the server device 200 with the second feature value corresponding to the third data.

In detail, the electronic device 100 may divide the third data 710 into a plurality of blocks. The electronic device 100 may determine that feature values of some blocks among the plurality of blocks included in the divided third data 710 and the feature values of some blocks included in the first data 410 do not match each other. Here, the electronic device 100 may determine that some blocks, which are identified as having the feature value not matching, are falsified.

For example, the electronic device 100 may divide the third data 710 shown in FIG. 7 into a plurality of blocks and then obtain the feature value for each block. Meanwhile, the operation for obtaining the feature value for each block is described above, and a detailed description thereof is thus omitted.

Here, the electronic device 100 may obtain the second key value corresponding to the third data 710 and then identify the first key value matching the second key value from the server device 200. The server device 200 may obtain the first feature value matching the first key value and stored therein.

The electronic device 100 may compare the first feature value with the second feature value. Here, the electronic device 100 may determine that a feature value in a signature region of the second feature value is different from a feature value in the signature region of the first feature value as a result of comparing the first feature value with the second feature value.

The electronic device 100 may determine that the signature region among the plurality of blocks included in the third data 710 is falsified. The electronic device 100 may display text including content that the signature region is falsified.

Meanwhile, this configuration is only one or more embodiments, and the electronic device 100 may determine whether some sections are falsified even if the third data is the audio data or the video data.

If the third data is the audio data or the video data, the electronic device 100 may compare the key frame obtained from the server device 200 with the key frame of the third data. Here, the electronic device 100 may determine that some of the key frames obtained from the server device 200 and some of the key frames included in the third data do not match each other. The electronic device 100 may determine that some sections identified as not matching are falsified.

For example, the electronic device 100 may determine that the key frame between 10 seconds and 15 seconds of the third data and the key frame between 10 seconds and 15 seconds of the first data do not match each other. In this case, the electronic device 100 may determine that the data between 10 seconds and 15 seconds of the third data are falsified.

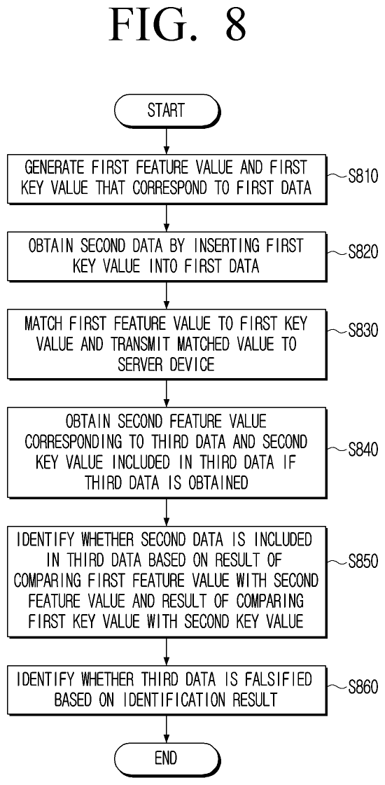

FIG. 8 is a flowchart for describing a method for controlling an electronic device according to one or more embodiments of the present disclosure.

First, the electronic device 100 may generate the first feature value and the first key value that correspond to the first data 410 (S810).

Meanwhile, for the convenience of description, one or more embodiments in which the electronic device 100 generates the first key value and then generates the first feature value is described above. However, this configuration is only one or more embodiments, and the electronic device 100 may generate the first feature value first and then generate the first key value.

Next, the electronic device 100 may obtain the second data by inserting the first key value into the first data 410 (S820). Here, the second data may include the first key value (or the watermark).

However, a general person may not be able to identify the first key value included in the second data.

The electronic device 100 may match the first feature value to the first key value and transmit the matched value to the server device (S830).

The electronic device 100 may obtain the second feature value corresponding to the third data and the second key value included in the third data if the third data is obtained (S840).

The electronic device 100 may determine whether the second data is included in the third data based on the result of comparing the first feature value with the second feature value and the result of comparing the first key value with the second key value (S850).

Next, the electronic device 100 may determine whether the third data is falsified based on the identification/determination result (S860).

According to the present disclosure, the electronic device 100 may determine whether various types of data are falsified. In addition, the electronic device 100 may also determine whether a “portion” of the data is falsified.

In addition, the method according to the various embodiments of the present disclosure may be included and provided in a computer program product. The computer program product may be traded as a commodity between a seller and a purchaser. The computer program product may be traded as a commodity between a seller and a purchaser. The computer program product may be distributed in a form of the machine-readable storage medium (for example, a compact disc read only memory (CD-ROM)) or online through an application store (for example, PlayStore™) or directly between two user devices 20 (e.g., smartphones). In case of the online distribution, at least a part of the computer program product (e.g., downloadable app) may be at least temporarily stored or temporarily provided in the machine-readable storage medium such as a memory of a server device of a manufacturer, a server device of an application store, or a relay server device.

The various embodiments of the present disclosure may be implemented by software including an instruction stored in the machine-readable storage medium (for example, the computer-readable storage medium). A machine may be an apparatus that invokes the stored instruction from the storage medium, may be operated based on the invoked instruction, and may include the server device or the electronic device according to the disclosed embodiments.

Meanwhile, the machine-readable storage medium may be provided in the form of a non-transitory readable recording medium. Here, the “non-transitory readable recording medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored.

If the instruction is executed by the processor, the processor may directly perform a function corresponding to the instruction or other components may perform the function corresponding to the instruction under a control of the processor. The instruction may include a code provided or executed by a compiler or an interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic device comprising:
memory storing instructions; and
at least one processor, wherein the instructions, when executed by the at least one processor collectively or individually, cause the electronic device to:
generate a first feature value and a first key value that correspond to first data;
obtain second data by inserting the first key value into the first data;
match the first feature value to the first key value and transmit a matched value to a server device;
based on third data being obtained, obtain a second feature value corresponding to the third data and a second key value in the third data;
determine whether the second data is in the third data based on a result of comparing the first feature value with the second feature value and a result of comparing the first key value with the second key value;
determine whether the third data is falsified based on an identification result; and
output information identifying whether the third data is falsified.

2. The electronic device as claimed in claim 1, wherein the instructions, when executed by the at least one processor collectively or individually, further cause the electronic device to:
determine whether a key value matching the second key value in the third data is stored in the server device;
obtain the first feature value matching the first key value and stored in the server device based on the server device comprising the first key value matching the second key value; and
identify the third data as non-falsified data based on the first feature value and the second feature value matching.

3. The electronic device as claimed in claim 1, wherein the instructions, when executed by the at least one processor collectively or individually, further cause the electronic device to:
generate the first key value based on at least one of a random number generation algorithm, a hash algorithm, binary information of the first data, or user information.

4. The electronic device as claimed in claim 1, wherein the instructions, when executed by the at least one processor collectively or individually, further cause the electronic device to:
divide the first data into a plurality of blocks based on the first data being image data; and
generate the first feature value based on a hash value of a block of the plurality of blocks in the divided first data.

5. The electronic device as claimed in claim 1, wherein the instructions, when executed by the at least one processor collectively or individually, further cause the electronic device to:
identify a key frame from among a plurality of frames in the first data based on the first data being video data or audio data; and
generate the first feature value based on feature information of the identified key frame.

6. The electronic device as claimed in claim 4, wherein the first feature value comprises information on at least one of content, capacity, format, resolution, or block size of the first data.

7. The electronic device as claimed in claim 1, wherein the instructions, when executed by the at least one processor collectively or individually, further cause the electronic device to:
identify the third data as falsified data based on the second key value not matching the first key value or the second key value in the third data being not obtainable.

8. The electronic device as claimed in claim 7, wherein the instructions, when executed by the at least one processor collectively or individually, further cause the electronic device to: identify the third data as the falsified data based on the second feature value and the first feature value not matching.

9. The electronic device as claimed in claim 4, wherein the instructions, when executed by the at least one processor collectively or individually, further cause the electronic device to:
divide the third data into a plurality of blocks; and
identify that one or more blocks in the divided third data are falsified based on hash values of the one or more blocks and hash values of one or more blocks in the divided first data not matching.

10. A method for controlling an electronic device, the method comprising:
generating a first feature value and a first key value that correspond to first data;
obtaining second data by inserting the first key value into the first data;
matching the first feature value to the first key value and transmitting a matched value to a server device;
obtaining a second feature value corresponding to third data and a second key value in the third data based on the third data being obtained;
determining whether the second data is in the third data based on a result of comparing the first feature value with the second feature value and a result of comparing the first key value with the second key value;
determining whether the third data is falsified based on an identification result; and
outputting information identifying whether the third data is falsified.

11. The method as claimed in claim 10, further comprising:
determining whether a key value matching the second key value in the third data is stored in the server device;
obtaining the first feature value matching the first key value and stored in the server device based on the server device comprising the first key value matching the second key value; and
identifying the third data as non-falsified data based on the first feature value and the second feature value matching.

12. The method as claimed in claim 10, wherein the generating of the first feature value comprises generating the first key value based on at least one of a random number generation algorithm, a hash algorithm, binary information of the first data, or user information.

13. The method as claimed in claim 10, wherein the obtaining of the first feature value comprises:
dividing the first data into a plurality of blocks based on the first data being image data; and
generating the first feature value based on a hash value of a block of the plurality of blocks in the divided first data.

14. The method as claimed in claim 10, wherein the obtaining of the first feature value comprises:
identifying a key frame from among a plurality of frames in the first data based on the first data being video data or audio data; and
generating the first feature value based on feature information of the identified key frame.

15. A non-transitory computer-readable recording medium storing computer instructions executed by at least one processor of an electronic device to cause the electronic device to perform a method for controlling the electronic device comprising:
generating a first feature value and a first key value that correspond to first data;
obtaining second data by inserting the first key value into the first data;
matching the first feature value to the first key value and transmitting a matched value to a server device;
obtaining a second feature value corresponding to third data and a second key value in the third data based on the third data being obtained;
determining whether the second data is in the third data based on a result of comparing the first feature value with the second feature value and a result of comparing the first key value with the second key value;
determining whether the third data is falsified based on an identification result; and
outputting information identifying whether the third data is falsified.

16. The non-transitory computer-readable recording medium as claimed in claim 15, wherein the method further comprises:
determining whether a key value matching the second key value in the third data is stored in the server device;
obtaining the first feature value matching the first key value and stored in the server device based on the server device comprising the first key value matching the second key value; and
identifying the third data as non-falsified data based on the first feature value and the second feature value matching.

17. The non-transitory computer-readable recording medium as claimed in claim 15, wherein the method further comprises:
generating the first key value based on at least one of a random number generation algorithm, a hash algorithm, binary information of the first data, or user information.

18. The non-transitory computer-readable recording medium as claimed in claim 15, wherein the method further comprises:
dividing the first data into a plurality of blocks based on the first data being image data; and
generating the first feature value based on a hash value of a block of the plurality of blocks in the divided first data.

19. The non-transitory computer-readable recording medium as claimed in claim 15, wherein the method further comprises:
identifying a key frame from among a plurality of frames in the first data based on the first data being video data or audio data; and
generating the first feature value based on feature information of the identified key frame.

20. The non-transitory computer-readable recording medium as claimed in claim 18, wherein the first feature value comprises information on at least one of content, capacity, format, resolution, or block size of the first data.
